(19) United States
(12) Patent Application Publication
(10) Pub. No.: US 2010/0275417 A1
(43) Pub. Date: Nov. 4, 2010

(54) SLIPPING-FREE ONE-WAY BUCKLE

(76) Inventor: MING-SHUN YANG, Taipei (TW)

Correspondence Address: LEONG C LEI, PMB # 1008, 1867 YGNACIO VALLEY ROAD, WALNUT CREEK, CA, 94598, US

(21) Appl. No.: 12/484,261

(22) Filed: Jun. 15, 2009

(30) Foreign Application Priority Data
Apr. 30, 2009 (TW) 098114464

(51) Int. Cl. F16G 11/14

(52) U.S. Cl. 24/115 L

(57) ABSTRACT

A slipping-free one-way buckle includes a main body composed of a seat and a housing and containing therein two rollers, a turntable, a wheel, and a switching device. The switching device is arranged to project sideways from sidewalls of the seat and the housing and includes a tongue, a stop block, and a switching arm. By being connected with a spring, the stop block can be automatically returned after being displaced for switching so as to position the tongue against one-way ratcheting teeth formed on the turntable. With a rope extending around the turntable and the wheel, a slipping-free one-way buckle is formed. As such, when the switching device is switched by a user's finger, unlocking of buckle is realized.

### TECHNICAL FIELD OF THE INVENTION

The present invention generally relates to a slipping-free buckle that allows a rope to move or slide in a single given direction to tighten an object and prevents the rope from slipping in a specific direction, so as to make buckle unlocking easy and allows single hand operation for applications where undesired loosening must be prevented for an object tightened with a rope.

### DESCRIPTION OF THE PRIOR ART

The present inventor has previously developed slipping free one-way buckles, such as U.S. Pat. No. 7,111,572, which discloses a hook seat tightening structure for ship covers, as shown in FIG. 9 of the attached drawings. The conventional slipping-free rope buckle 1 shown in FIG. 9 is constructed to comprise a body constituted by a seat 10 and a housing 20 and the buckle body contains therein two rollers 13, a turntable 30, a wheel 35, a lock bolt 40, and a lock member 50. A depressing piece 41 and a tenon 42 are provided at opposite sides of the lock bolt 40. The tenon 42 is connected with a spring 43 to automatic return the lock bolt after rotation. The depressing piece 41 abuts against one-way ratchets 37 formed on the turntable 35. The lock member 50 is operated with an external key 60 for rotation.

Alternatively, the lock member 50 is omitted to avoid the locking and unlocking operation preformed with the key. Another example is shown in U.S. patent application Ser. No. 11/480,962, which discloses a latch-type tightening device structure as shown in FIG. 10 of the attached drawings. The rope tightening device 1 shown in FIG. 10 comprises a tenon 27 or latching slot 28 formed in the front edge of a main body to allow buckles on opposite sides to quickly buckle together. A rope 80 reeves around a turntable 30 and a wheel 35 to form the buckle that allows the rope to move in a single direction. When a lock bolt 40 is switched to disengage a depressing piece 41 from one-way ratchets 37, the rope 80 is allowed to move in a clockwise direction to release the rope.

In the conventional buckles shown in FIGS. 9 and 10, the unlocking operation is performed by a lock bolt 40 that is controlled for rotation by a knob 55 set outside the main body and is combined together with a screw 56 extending through the knob 55 and engages a threaded bore 45 defined in the lock bolt 40. The lock bolt 40 forms a latching plane 44 in a top thereof for latching into a corresponding non-circular hole defined in a bottom surface of the knob 55 so that when the knob 55 is rotated, the lock bolt 40 rotates simultaneously. This arrangement sets the knob 55 for releasing the rope on the housing 20 and thus it needs to be operated with two fingers of one hand and another hand applying a force to pull the rope 80. The operation of releasing rope cannot be performed with a single hand. Improvement is thus needed.

In view of this problem, the invention aims to provide a slipping-free one-way rope tightening buckle that has a simple structure and can be easily operated with a single hand in order to facilitate tightening of an object.

### SUMMARY OF THE INVENTION

An objective of the present invention is to provide a slipping-free one-way buckle, which can be operated with one hand to realize a continuous operation mode for unlocking the buckle and releasing a rope secured with the buckle so as to make the operation simple and easy.

To achieve the above objective, the present invention provides a buckle, which comprises generally a main body composed of a seat and a housing and containing therein two rollers, a turntable, a wheel, and a switching device. The switching device comprises a tongue, a stop block, and a switching arm. The stop block is subjected to spring biasing for resilient returning of the switching device after the device has been switched so as to control the timing of positioning the tongue against one-way ratcheting teeth formed on the turntable. The buckle provides an effect of preventing slipping of a rope in a single given direction and when the switching arm is displaced for switching, loosening of the rope and unlocking the buckle can be achieved.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the structure of the present invention.

FIG. 2 is a bottom perspective view of a housing of the present invention.

FIG. 3 is a perspective view of a slipping-free one-way buckle of the present invention in an assembled form.

FIG. 4 is a schematic view illustrating a rope extending around the present invention.

FIG. 5 is a cross-sectional view illustrating that the rope is allowed to move when pulled counterclockwise and is slipping-free and secured when pulled clockwise.

FIG. 6 is a cross-sectional view illustrating that when a switching device is switched for unlocking to allow the rope to move clockwise.

FIG. 7 shows an embodiment where a metal ring plate is attached to a front end of the present invention.

FIG. 8 shows an embodiment where tenon projections and locking slots are provided at front end of the present invention.

FIG. 9 is an exploded view of a known buckle disclosed in U.S. Pat. No. 7,111,572.

FIG. 10 is a perspective view of a known buckle disclosed in U.S. patent application Ser. No. 11/480,962.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

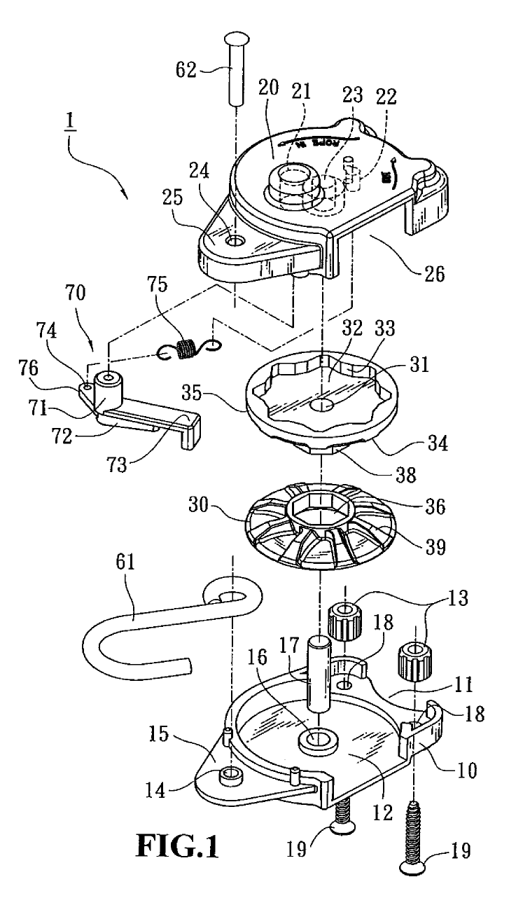

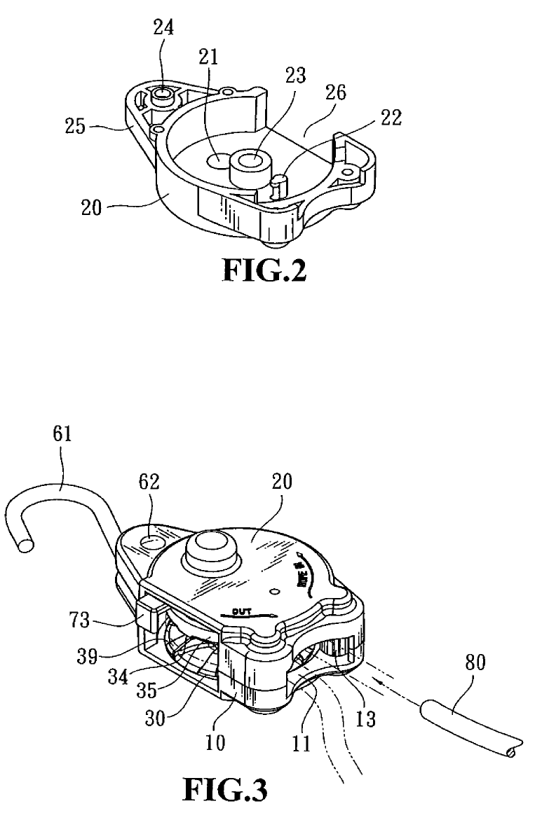

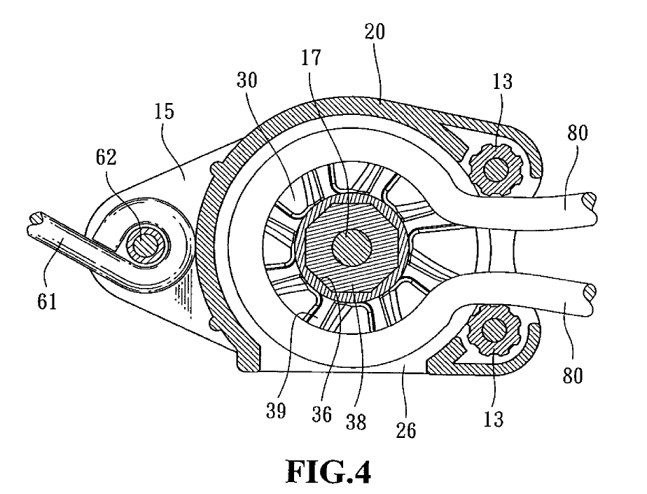

Referring to FIGS. 1 and 2, a slipping-free one-way buckle constructed in accordance with the present invention, generally designated at 1, comprises a seat 10, a housing 20, a turntable 30, a wheel 35, and a switching device 70. The seat 10 forms a rope access opening 11 at a rear end thereof and two screw holes 18 are respectively formed at opposite sides of the opening 11. Two rollers 13 are respectively set above the screw holes 18 and two screws 19 are respectively inserted upward from the lower side through the screw holes 18 and further extend through the rollers 13 to engage and fix to the housing 20 so as to rotatably retain the rollers 13 on the opposite sides of the opening 11 for the purposes of protecting a rope 80 (see FIG. 4) from damage caused by abrading within the opening 11 in the course of being pulled. The seat 10 forms at a center thereof a cavity 12 of which a side wall forms a cutoff. In the center of the cavity, a bore 16 is formed. A central pin 17 is coupled in the bore 16. The seat 10 has a front end from which a flange 15 projects. The projecting flange 15 forms a through hole 14 at a central portion thereof. As shown in FIG. 2, the housing 20 forms a positioning hole 21, a positioning pin 22, and a bore 23 and has a front end from which a flange 25 projects. The projecting flange 25 forms a through hole 24 at a central portion thereof. The housing 20 defines a cavity that is delimited by a side wall that forms a cutoff 26. The wheel 35 forms a central through hole 31. The wheel 35 has a top surface forming a recess 32. The recess 32 is delimited by an inner circumferential wall forming one-way ratcheting teeth 33. The wheel 35 has a bottom constituted by a board having a thick central portion and a thinned circumferential portion and forming a plurality of ribs 34 extending radially from a center defined by the through hole 31 and defining, at a center thereof, a polygonal pillar 38 that corresponds to a bore 36. The ribs 34 are arranged to correspond to ribs 39 formed on the turntable 30 to collectively engage and be thus driven by the rope 80 (see FIG. 4). The turntable 30 is constituted by a board having a thick central portion and a thinned circumferential portion. The turntable 30 defines, in a center thereof, the bore 36 (which is an octagonal hole in the drawings) having a circumference from which the ribs 39 extend radially. The bore 36 is fit over and coupled to the pillar 38. In the embodiment illustrated, synchronized rotation is realized through fitting of the pillar 38 on the bottom of the wheel 35 to the bore 36 of the turntable 30, or alternatively, the turntable 30 and the wheel 35 can be integrally formed together, for example the pillar 38 on the bottom of the wheel 35 and the bore 36 defined in the top of the turntable 30 are integrally formed together to provide an equivalent substitute structure.

The switching device 70 comprises a top post 71. A switching arm 73 is formed on one side of the top post 71 and a tongue 76 is formed on an opposite side of the post 71. The tongue 76 defines a through hole 74. A stop block 72 is mounted to an underside of the switching arm 73.

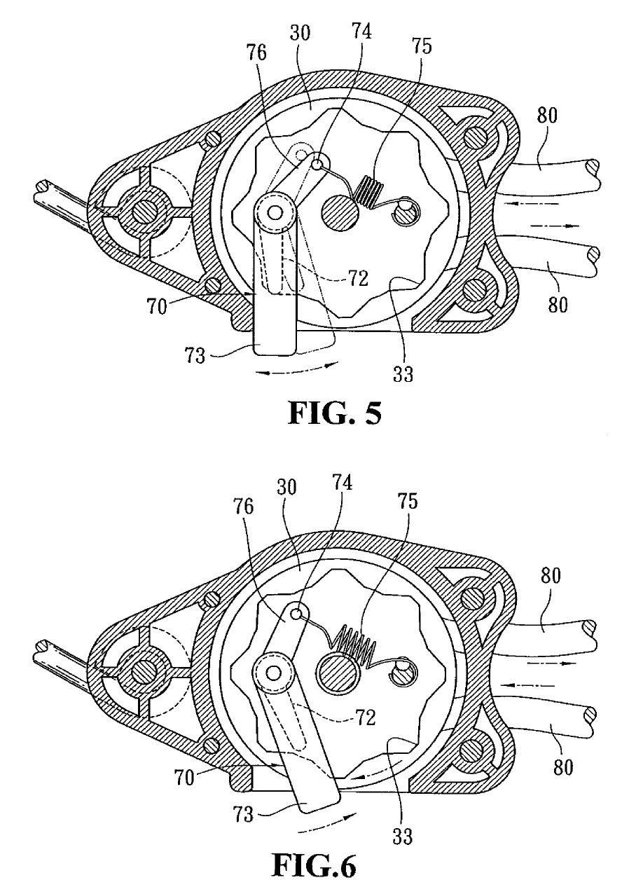

Referring to FIG. 3, to assemble, the through hole 14 formed in the projecting flange 15 of the seat 10 receives a hook 61 positioned thereon and a fastener or rivet 62 is inserted through the through hole 24 of the housing 20 and extending through the hook and the through hole 14 and then fixed. The turntable 30 and the wheel 35 are put together and fit over the central pin 17. The switching device 70 is set between the recess 32 and the positioning hole 21. A spring 75 has opposite ends that are respectively attached to the through hole 74 of the switching device 70 and the positioning pin 22 on the underside of the housing 20 in such a way that the stop block 72 is resiliently biased to position against the one-way ratcheting teeth 33 (see FIG. 5). Finally, the two screws 19 are inserted upward from the lower side through the screw holes 18 and further through the rollers 13 to engage and fix to the housing 20 to thereby form the slipping-free buckle.

Referring to FIGS. 4 and 5, the rope 80 is inserted through the right side of the opening 11 and passes between the ribs 34, 39 of the turntable 30 and the wheel 35 to curve in the counterclockwise direction and then exits through the left side of the opening 11, whereby the rope 80 is allowed to be pulled out in the counterclockwise direction, but is locked in a slipping free manner when retracted in a clockwise direction.

Referring to FIG. 5, with the rope 80 fed in through the right side of the access opening of the buckle 1, extending counterclockwise around the turntable 30 and the wheel 35, and then exiting through the left side of the access opening, pulling the rope 80 counterclockwise causes the turntable 30 and the wheel 35 to rotate due to surface friction thereof with the rope 80. When the rope 80 is pulled clockwise, the one-way ratcheting teeth 33 of the wheel 35 engages and stops the stop block 72 so as to prevent rotation and thus achieving the effect of securing and resistance of slipping.

Referring to FIG. 6, when the buckle 1 is operated with one hand (taking the right hand as an example), the thumb moves the switching arm 73 of the switching device 70 to disengage the stop block 72 from the one-way ratcheting teeth 33 so as to allow the shell to move and allow the rope 80 to slide for releasing the securing.

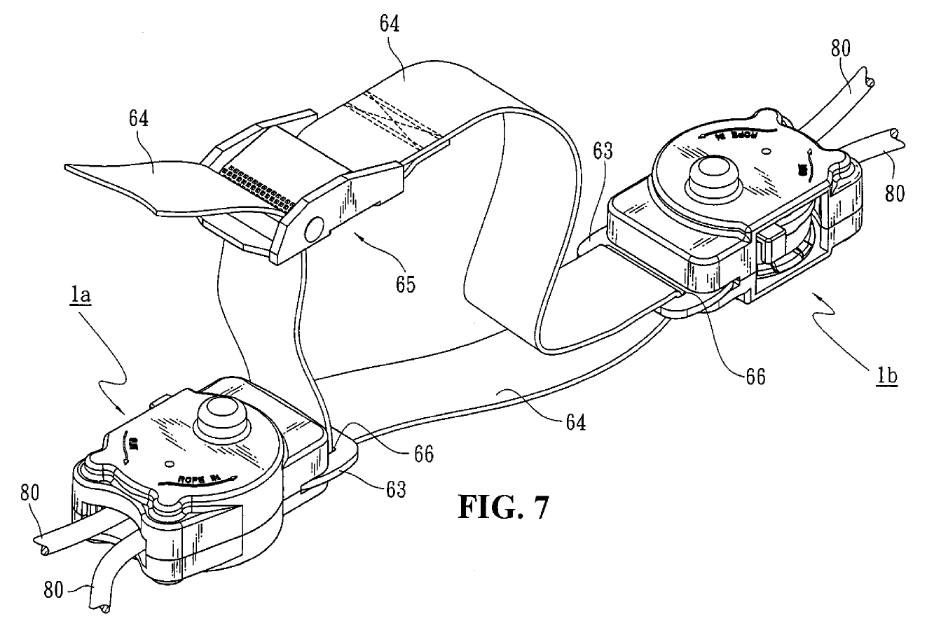

Referring to FIG. 7, an embodiment where slipping-free buckles 1a, 1b of the present invention are coupled to metal ring plates 63 at front ends thereof is shown. When the slipping-free buckles 1a, 1b are coupled with metal ring plates 63 at the front ends thereof, two slipping-free one-way buckles 1a, 1b, a length of rope 80, a band 64, and a locking buckle 65 are used, wherein an end of the band 64 is attached to the locking buckle 65 and an extension end is put through a slot 66 defined in the metal ring plate 63 of the slipping-free one-way buckle 1 at one side. The band 64 then extends through a slot 66 of the metal ring plate 63 of the slipping-free one-way buckle 1a at the other side. Finally, the end of the band 64 is fed through the lock buckle 65 so that the band 64 connects between the two slipping-free one-way buckles 1a, 1b. The rope 80 coupled to the two slipping-free one-way buckles 1a, 1b is thus provided with the advantages of easy tightening and releasing.

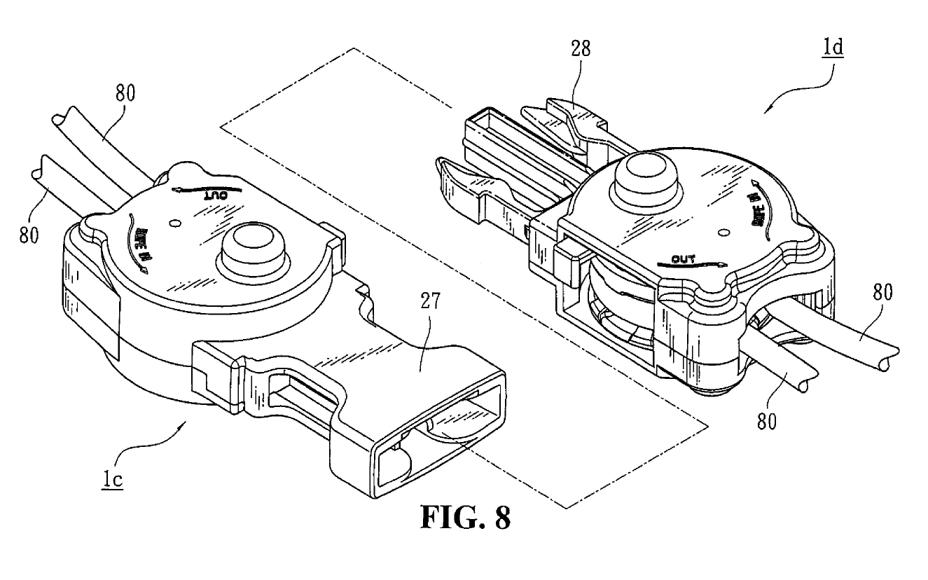

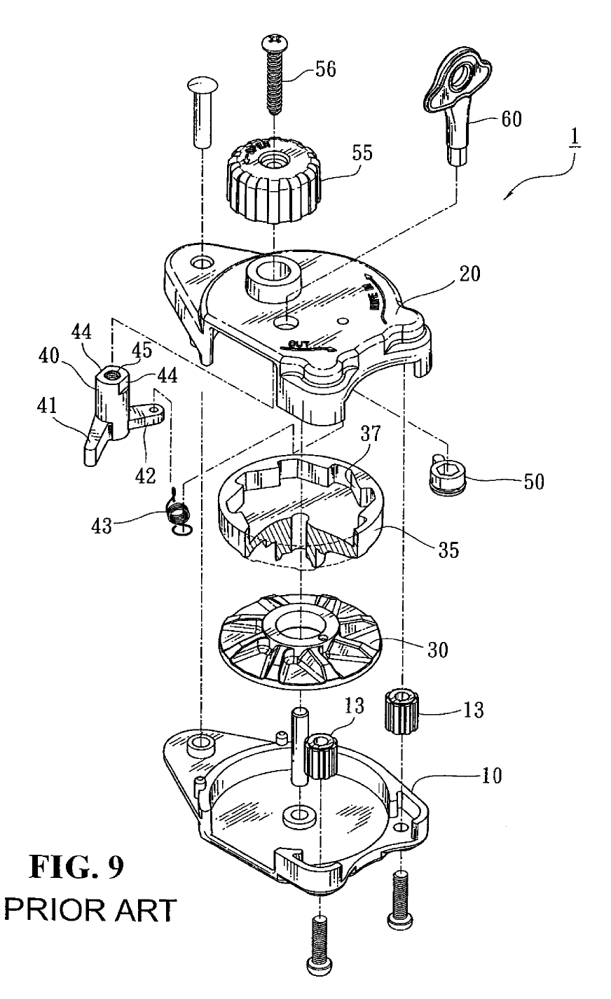

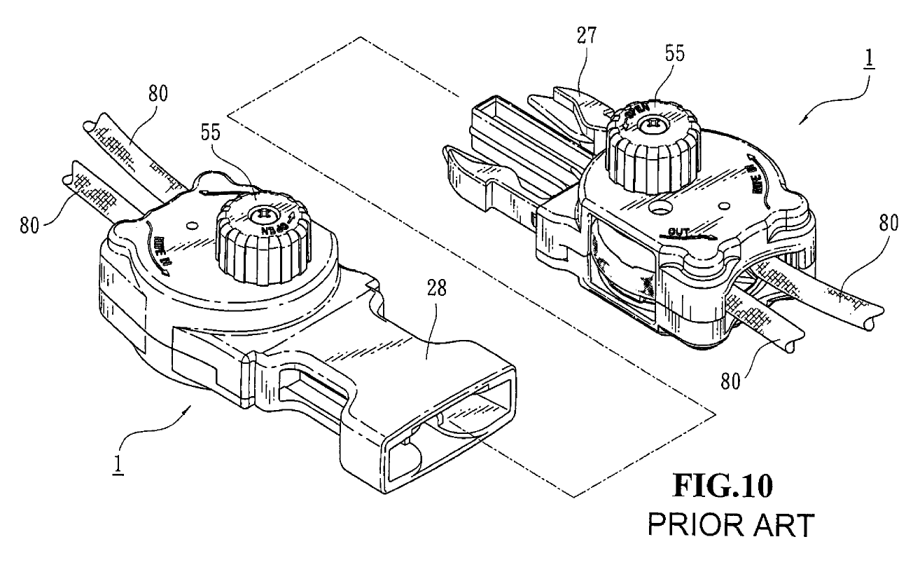

Referring to FIG. 8, an embodiment where slipping-free buckles 1c, 1d of the present invention are provided, at front ends thereof, with tenon projections 27 and locking slots 28 is shown. With this arrangement, the slipping-free buckles 1c, 1d can be efficiently buckled together to ease the operation of stretching the rope 80 for tightening. To release, the tenon projections 27 are depressed for releasing in a springing manner thereby ensuring efficient releasing of rope.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A slipping-free one-way buckle, comprising a seat, a housing, a turntable, a wheel, and a switching device, characterized in that:
the seat forming an access opening at a rear end thereof, the seat forming a cavity at a central portion thereof, a central pin being set on a center of the cavity;
the housing forming an access opening at a rear end thereof, the housing forming a cavity at a central portion thereof, the housing forming a positioning hole;
the wheel having a top surface defining a recess delimited by an inside circumferential wall forming one-way ratcheting teeth, the wheel forming a central through hole and having a bottom forming a plurality of radially extending ribs centered at the central through hole, a pillar being set at the center;
the turntable forming in a center thereof a bore having a circumference from which ribs extend radially;
the switching device comprising a top post, which has one side to which a switching arm is mounted and an opposite side to which a tongue is mounted, the tongue defining a through hole, a stop block mounted to an underside of the switching arm;
the housing being matingly combined to the seat to have the two shells integrated together.

2. The slipping-free one-way buckle according to claim 1, wherein the shell of the combined housing and seat is provided at a front end thereof with a hook.

3. The slipping-free one-way buckle according to claim 1, wherein the slipping-free buckle has a front end to which a metal ring plate is attached.

4. The slipping-free one-way buckle according to claim 1, wherein the slipping-free buckle has a front end to which tenon projections are mounted.

5. The slipping-free one-way buckle according to claim 1, wherein the slipping-free buckle has a front end in which locking slots are defined.
